(19) United States
(12) Patent Application Publication
(10) Pub. No.: US 2023/0024475 A1
(43) Pub. Date: Jan. 26, 2023

(54) SECURITY AWARE LOAD BALANCING FOR A GLOBAL SERVER LOAD BALANCING SYSTEM

(71) Applicant: VMware, Inc., Palo Alto, CA (US)

(72) Inventors: Narasimhan Gomatam Mandeyam, San Jose, CA (US); Sambit Kumar Das, Hayward, CA (US); Shyam Sundar Govindaraj, Santa Clara, CA (US)

(21) Appl. No.: 17/381,010

(22) Filed: Jul. 20, 2021

(51) Int. Cl. H04L 29/06; H04L 29/12

(52) U.S. Cl. CPC H04L 63/1458; H04L 63/1416; H04L 61/1511; H04L 61/2507

(57) ABSTRACT

The method of some embodiments protects multiple datacenters that implement an application. The datacenter include multiple DNS clusters for assigning clients to the datacenters. The method is performed at a first datacenter. The method receives, from a second datacenter, a security notification identifying a set of clients that pose a security threat. The method stores a set of identifiers associated with the set of clients on a deny-list. Prior to responding to a DNS request from a particular client, the method determines whether the particular client is on the deny-list. The method rejects the DNS request when the particular client is on the deny-list. The method processes the DNS request when the particular client is not on the deny-list.

In the field of accessing applications that operate partially or entirely on servers or other machines accessed over a network such as the Internet, a typical application access first involves a client device (e.g., a computer, smart phone, tablet device, etc.) sending a domain name system (DNS) request to a DNS service engine. In return, the client receives a DNS response that includes a list of one or more IP addresses where the application is hosted. The IP addresses may be specific addresses of servers hosting the application, but commonly are virtual IP (VIPs) addresses that the client can use to send data to a network address translation (NAT) system or load balancer that forwards the data to a specific server that runs the application.

The DNS service engine can use a simplistic scheme such as round robin to cycle through the list of available IP addresses. In practice and commercially however, a DNS service engine usually operates in conjunction with a “Global Server Load Balancing” (GSLB) solution. A GSLB solution ensures that the incoming client requests are load balanced amongst the available sites, domains, and IP addresses, based on more sophisticated criterion such as: site or server load, proximity of clients to servers, server availability, performance parameters of latency and response times, etc. However, the prior art GSLB systems do not account for security issues that may arise at a datacenter that contains one set of servers for implementing the application for the client. In such prior art systems, the load balancers (LBs) of a GSLB system may assign a client to a datacenter that is undergoing a denial of service (DOS) attack. The DOS attack in some cases might result in poor performance of the application for the client, and assigning additional clients to a datacenter undergoing a DOS attack might exacerbate the situation and cause the DOS to take longer to resolve. Other security issues may make the servers of a particular datacenter less desirable to assign a customer to, but again, the prior art GSLB systems are not able to respond to such security issues. Therefore, there is a need in the art for security aware GLSB systems.

### BRIEF SUMMARY

The method of some embodiments assigns a client to a particular datacenter from among multiple datacenters. The method is performed at a first datacenter, starting when it receives security data associated with a second datacenter. The method receives a DNS request from the client for a set of services provided by an application (e.g., a web server, an appserver, a database server, etc.) that executes on multiple computers operating in multiple datacenters. Based on the received security data, the method sends a DNS reply assigning the client to the particular datacenter instead of the second datacenter. The receiving and sending is performed by a DNS cluster of the datacenter in some embodiments. The particular datacenter includes a set of physical servers (i.e., computers) implementing the application for the client in some embodiments. The datacenter to which the client gets assigned can be the first datacenter or a third datacenter.

The security data is associated with a set of servers, at the second datacenter, that implement applications for clients in some embodiments. The security data is collected by hardware or software security agents at the second datacenter in some embodiments. These security agents can be implemented on the servers of second datacenter. The security agents monitor security reports generated by smart network interface cards (smart NICs) in the second datacenter in some embodiments.

The security data may indicate any of several different security conditions in different embodiments. The security data can indicate a compromised or less secure application at the second datacenter. The application is indicated to be less secure when not all available security patches have been applied to the application, in some embodiments.

In some embodiments, the DNS request is a first DNS request and the client is a first client. The method in some such embodiments also generates a source-IP deny-list based at least partly on the security data. The method receives a second DNS request from a second client. The method matches a source IP of the second DNS request with an IP address on the source-IP deny-list and drops the second DNS request based on the matching of the source IP and the IP address on the source-IP deny-list.

The preceding Summary is intended to serve as a brief introduction to some embodiments of the invention. It is not meant to be an introduction or overview of all inventive subject matter disclosed in this document. The Detailed Description that follows and the Drawings that are referred to in the Detailed Description will further describe the embodiments described in the Summary as well as other embodiments. Accordingly, to understand all the embodiments described by this document, a full review of the Summary, the Detailed Description, the Drawings, and the Claims is needed. Moreover, the claimed subject matters are not to be limited by the illustrative details in the Summary, the Detailed Description, and the Drawings.

### BRIEF DESCRIPTION OF THE DRAWINGS

The novel features of the invention are set forth in the appended claims. However, for purposes of explanation, several embodiments of the invention are set forth in the following figures.

FIG. 1 illustrates an example of a security aware GSLB system.

FIG. 2 conceptually illustrates a process of some embodiments for selecting a sending a DNS reply to a client.

FIG. 3 illustrates operations of security elements of a datacenter that is under a DOS attack.

FIG. 4 illustrates operations of security elements of a datacenter that passes security data through controllers instead of DNS clusters.

FIG. 5 conceptually illustrates a process for protecting a datacenter from a client involved in an attack on another datacenter in a security aware GSLB system.

FIG. 6 illustrates a DNS cluster of some embodiments.

FIG. 7 conceptually illustrates a computer system with which some embodiments of the invention are implemented.

### DETAILED DESCRIPTION

In the following detailed description of the invention, numerous details, examples, and embodiments of the invention are set forth and described. However, it will be clear and apparent to one skilled in the art that the invention is not limited to the embodiments set forth and that the invention may be practiced without some of the specific details and examples discussed.

The method of some embodiments assigns a client to a particular datacenter from among multiple datacenters. The method is performed at a first datacenter, starting when it receives security data associated with a second datacenter. The method receives a DNS request from the client for a set of services provided by an application (e.g., a web server, an appserver, a database server, etc.) that executes on multiple computers operating in multiple datacenters. Based on the received security data, the method sends a DNS reply assigning the client to the particular datacenter instead of the second datacenter. The receiving and sending is performed by a DNS cluster of the datacenter in some embodiments. The particular datacenter includes a set of physical servers (i.e., computers) implementing the application for the client in some embodiments. The datacenter to which the client gets assigned can be the first datacenter or a third datacenter.

The security data is associated with a set of servers, at the second datacenter, that implement applications for clients in some embodiments. The security data is collected by hardware or software security agents at the second datacenter in some embodiments. These security agents can be implemented on the servers of second datacenter. The security agents monitor security reports generated by smart network interface cards (smart NICs) in the second datacenter in some embodiments.

The security data may indicate any of several different security conditions in different embodiments. The security data can indicate a compromised or less secure application at the second datacenter. The application is indicated to be less secure when not all available security patches have been applied to the application, in some embodiments.

In some embodiments, the DNS request is a first DNS request and the client is a first client. The method in some such embodiments also generates a source-IP deny-list based at least partly on the security data. The method receives a second DNS request from a second client. The method matches a source IP of the second DNS request with an IP address on the source-IP deny-list and drops the second DNS request based on the matching of the source IP and the IP address on the source-IP deny-list.

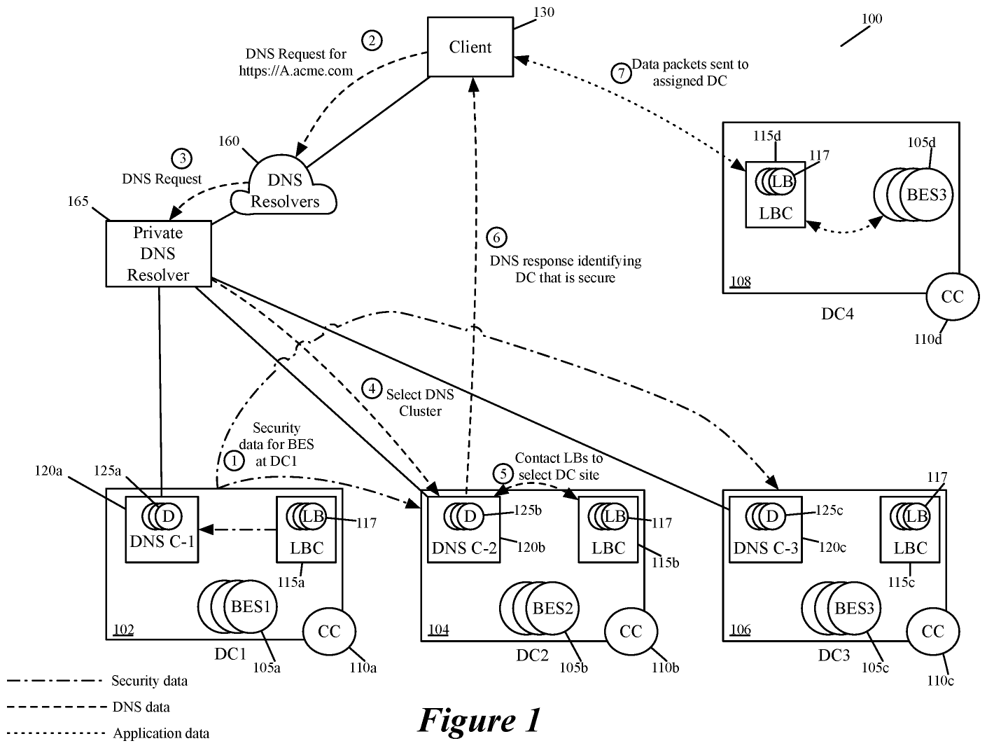

FIG. 1 illustrates an example of a security aware GSLB system 100. In this example, backend application servers 105a-d are deployed in four datacenters 102-108. In some embodiments, one or more of these datacenters may be either public datacenters or private datacenters. The datacenters in this example are in different geographical sites (e.g., different neighborhoods, different cities, different states, different countries, etc.).

A cluster of one or more controllers 110a-d are deployed in each datacenter 102-108. Each datacenter also has a cluster 115a-d of load balancers 117 to distribute the client load across the backend application servers 105a-d in the datacenter. In this example, the datacenters 102-106 also have a cluster 120a-c of DNS service engines 125a-c to perform DNS operations to process (e.g., to provide network addresses for domain names provided by) DNS requests submitted by clients 130 inside or outside of the datacenters. In some embodiments, the DNS requests include requests for fully qualified domain name (FQDN) address resolutions. In some embodiments, one or more DNS service engines 125a-c, load balancers 117, and backend servers 105a-d may be implemented on a host computer (not shown) of the datacenter. In some embodiments, some individual host computer may include at least one DNS service engine 125a-c, at least one load balancer 117, and at least one backend server 105a-d. In some embodiments, load balancers 117 are implemented by service virtual machines (SVMs) and backend servers 105a-d are implemented by guest virtual machines (GVMs) on the same host computer.

Although datacenters 102-106 all include DNS service engines 125a-c, in some embodiments, datacenters such as 108 may include backend servers 105d and load balancers 117 or other elements for assigning a client to a particular backend server 105d but not include DNS service engines. Although several embodiments are described herein as including backend servers, in some embodiments the applications run partially or entirely on other kinds of servers, host computers, or machines of the datacenter. Similarly, one of ordinary skill in the art will understand that in some embodiments of the invention a portion of the application also runs partly on the client (e.g., an interface may run on the client that displays data supplied by the servers, some other functions of the application may be implemented by executable code running on the client, etc.). In general, servers that run at least some part of the application may be referred to as “application servers.”

FIG. 1 illustrates the resolution of an FQDN that refers to a particular application “A” that is executed by the servers of the domain acme.com. As shown, this application is accessed through https and the URL “A.acme.com”. The security aware GSLB operation is shown in multiple steps. First, security data is sent from the datacenter 102 to the datacenters 104 and 106 that contain DNS clusters 120b and 120c. The security data may include data about DOS attacks (e.g., that there is an ongoing attack, IP addresses of attackers to be added to a source-IP deny-list, etc.), compromised (or less secure) applications, other security insights produced by monitoring tools, etc. The types of security threats identified by the monitoring tools could include packets that are bad and/or malformed at the physical and/or data link layers (L1/L2 layers), volumetric attacks, TCP attacks, SYN-attacks, reset (RST)-attacks, HTTP attacks, URL misinterpretation, SQL Query poisoning, reverse proxying, session hijacking etc.

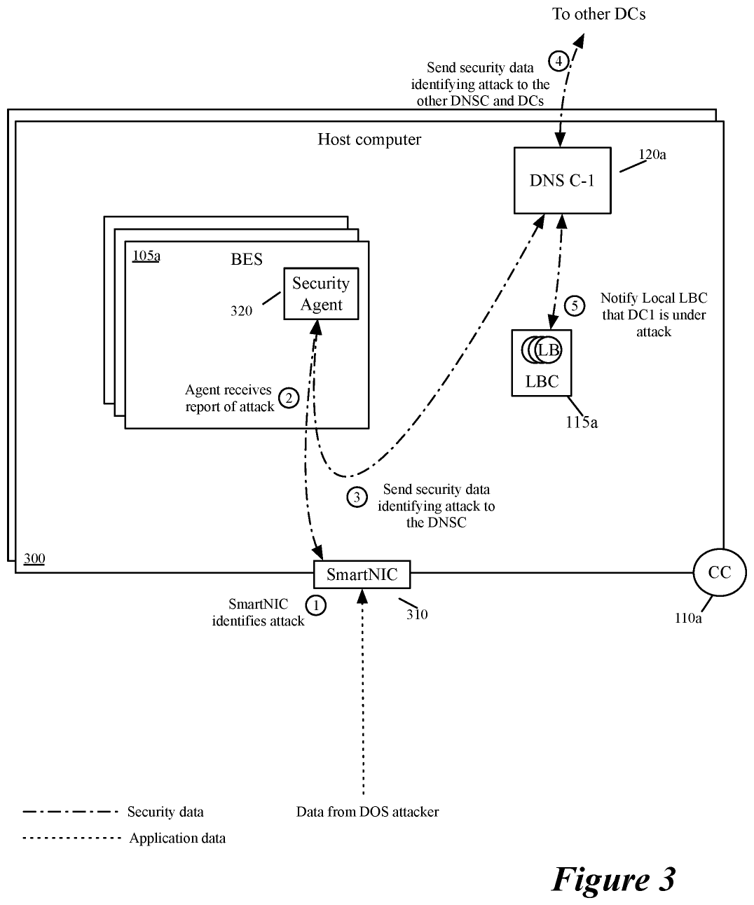

Different embodiments may generate or collect the security data from one or more sources at the datacenter. Some examples of software, hardware, or elements that include a combination of hardware and software that collect metrics to produce security data include (1) a smart network interface card (smartNIC) of a server or host computer of the datacenter, (2) a load balancer 117, (3) load balancer agents on the BES 105a-d, (4) DNS clusters 120a-c (or DNS service engines 125a-c), (5) DNS cluster agent operating on the BESs 105a-d, and/or (6) other agents on host computers of the backend server. In some embodiments, one or more of the above elements collects metrics from third party hardware or software, such as an agent collecting alerts from a smartNIC. Additionally, some elements may collect data from multiple sources, such as receiving alerts from smartNICs and security update status information from backend servers, etc. Examples of servers 105a-d with agents are described in more detail with respect to FIG. 3, below.

In the description of the illustrated example, the security data is assumed to be serious enough to warrant barring the datacenter 102 from being assigned new clients (e.g., until a DOS attack is resolved and new security data clears the GSLB system to begin assigning clients to datacenter 102 again). However, in some embodiments, security data may be serious enough to warrant some action, but not indicate enough of a threat to warrant entirely barring a datacenter. For example, the security data may indicate that the latest security patches have been applied to applications at a first datacenter, but not applications at a second datacenter. The security aware GSLB system in such embodiments could create a preference for assigning clients to the first datacenter until the second datacenter is up-to-date on its security patches.

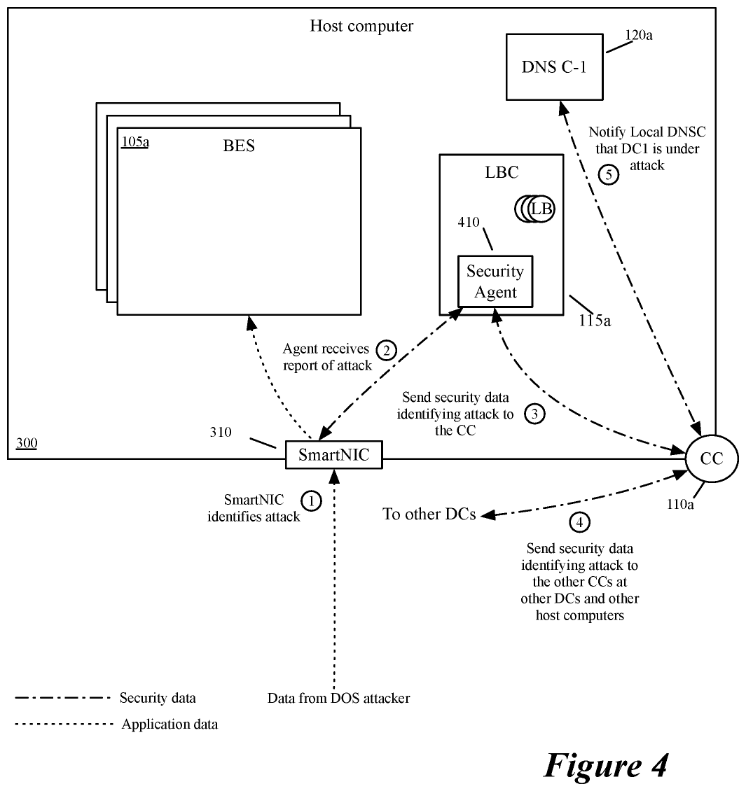

Although FIG. 1 shows the security data passing through the DNS cluster 120a and being send to DNS clusters 120b and 120c, in other embodiments, the security data may be sent directly from the servers 105a to DNS clusters 120b and 120c. In some embodiments, different routing operations are performed depending on routing choices by administrators of the GSLB system or selected automatically depending on available elements in the datacenters. For example, in some embodiments, security data from servers in a datacenter with a DNS cluster, such as datacenters 102-106, would be sent out through the DNS cluster, but security data from servers in a datacenter without a DNS cluster, such as datacenter 108 would be send directly from the servers 105d, through the load balancers, or through the controllers 110d. However, in other embodiments, even a datacenter with a DNS cluster may send security data out through some other element such as the controllers, etc., as further described with respect to FIG. 4.

The next parts of the security aware GSLB operation happen after the security data is received at a DNS cluster. Labeled as second in the figure, a DNS request comes in from a client 130, through a DNS resolver 160. The DNS resolver 160 is a server on the Internet that converts a domain name into an IP addresses, or as it does here, forwards the DNS request to another DNS resolver 165. Third, the DNS request is forwarded to a private DNS resolver 165 of the enterprise that owns or manages the private datacenters 102-108. Fourth, the private DNS resolver 165 selects one of the DNS clusters 120a-c. This selection is random in some embodiments, while in other embodiments it is based on a set of load balancing criteria that distributes the DNS request load across the DNS clusters 120a-c.

Fifth, the selected DNS cluster 120b resolves the domain name to an IP address. The IP address may be a virtual IP address associated with a particular datacenter, which is possibly one of multiple VIP addresses associated with that particular datacenter. In some embodiments, each DNS cluster includes multiple DNS service engines 125a-c, such as DNS service virtual machines (SVMs) that execute on host computers in the cluster's datacenter. When one of the DNS clusters 120a-c receives a DNS request, a frontend load balancer (not shown) in some embodiments selects one of the DNS service engines 125a-c in the cluster to respond to the DNS request, and forwards the DNS request to the selected DNS service engine. Other embodiments do not use a frontend load balancer, and instead have a DNS service engine serve as a frontend load balancer that selects itself or another DNS service engine in the same cluster for processing the DNS request.

The DNS service engine 125b, in some embodiments, contacts the load balancer 115b, which uses a set of criteria to select a VIP from among the VIPs of all datacenters that execute the application. The set of criteria for this selection in some embodiments includes (1) the security data or information derived from the security data, (2) the number of clients currently assigned to use various VIPs, (3) the number of clients using the VIPs at the time, (4) data about the burden on the backend servers accessible through the VIPs, (5) geographical or network locations of the client and/or the datacenters associated with different VIPs, etc. Also, in some embodiments, the set of criteria include load balancing criteria that the DNS service engines use to distribute the data message load on backend servers that execute application “A.”

In the example illustrated in FIG. 1, the selected backend server cluster is the server cluster 105d in the datacenter 108. Sixth, after selecting this backend server cluster 105d for the DNS request that it receives, the DNS service engine 125b of the DNS cluster 120b returns a DNS response to the requesting client 130. This response includes the VIP address associated with the selected backend server cluster 105d. In some embodiments, this VIP address is associated with the local load balancer cluster 115d that is in the same datacenter 108 as the selected backend server cluster. Datacenters without a DNS such as datacenter 108 may still include load balancers 115d for local load balancing operations (e.g., assigning each client to a particular backend server 105d). Although in this example, the backend server cluster 105d is in a datacenter 108 without a DNS cluster of its own, other clients (not shown) of the embodiment of FIG. 1 are assigned to backend server clusters 105b or 105c that include DNS clusters 120b and 120c, respectively.

In the illustrated example, no new clients would be assigned to servers 105a in datacenter 102. However, in some embodiments, security data may be received that results in a preference for or against assigning clients to a particular datacenter rather than an absolute bar. For example, a datacenter that has not implemented the latest security patch for the application may be less preferable than a datacenter that has implemented the security patch, but the load balancers could still assign a client to the less secure datacenter if all secure datacenters were operating at high or maximum capacity.

Seventh, after getting the VIP address, the client 130 sends one or more data message flows to the assigned VIP address for the backend server cluster 105d to process. In this example, the data message flows are received by the local load balancer cluster 115d and forwarded to one of the backend servers 105d. In some embodiments, each of the load balancer clusters 115a-d has multiple load balancing engines 117 (e.g., load balancing SVMs) that execute on host computers in the cluster's datacenter.

When the load balancer cluster receives the first data message of the flow, a frontend load balancer (not shown) in some embodiments selects a load balancing service engine 117 in the cluster to select a backend server 105d to receive the data message flow, and forwards the data message to the selected load balancing service engine 117. Other embodiments do not use a frontend load balancer, and instead have a load balancing service engine 117 in the cluster serve as a frontend load balancer that selects itself or another load balancing service engine 117 in the same cluster for processing the received data message flow.

When a selected load balancing service engine 117 processes the first data message of the flow, in some embodiments, this service engine uses a set of load balancing criteria (e.g., a set of weight values) to select one backend server from the cluster of backend servers 105d in the same datacenter 108. The load balancing service engine 117 then replaces the VIP address with an actual destination IP (DIP) address of the selected backend server (among servers 105d), and forwards the data message and subsequent data messages of the same flow to the selected backend server. The selected backend server then processes the data message flow, and when necessary, sends a responsive data message flow to the client 130. In some embodiments, the responsive data message flow is sent through the load balancing service engine that selected the backend server for the initial data message flow from the client 130.

In some embodiments, the load balancer cluster 115d maintains records of which server each client has previous been assigned to and when later data messages from the same client are received, the load balancer cluster 115d forwards the messages to the same server. In other embodiments, data messages sent to the VIP address are received by a NAT engine (not shown) that translates the VIP address into an internal address of a specific backend server. In some such embodiments, the NAT engine maintains records of which server each client is assigned to and sends further messages from that client to the same server. In some embodiments, the NAT engine may be implemented as part of the load balancer cluster 115d.

One of ordinary skill in the art will understand that the present invention applies to a wide variety of threats to datacenters and their servers, DNS clusters, load balancers, controllers, etc. The types of security threats identified and dealt with by the methods of some embodiments could include packets that are bad and/or malformed at the physical and/or data link layers (L1/L2 layers), volumetric attacks, TCP attacks, SYN-attacks, reset (RST)-attacks, HTTP attacks, URL misinterpretation, SQL Query poisoning, reverse proxying, session hijacking etc. Similarly, although the description of the attacks with respect to FIGS. 1-6 focus on security attacks against the application servers of datacenters, in some embodiments, the GSLB system determines datacenters to avoid based on attacks on other components of a datacenter. In some embodiments security data is sent through the same data streams as DNS and/or application data (e.g., in-band) alternatively, the security data may be sent through separate data streams (e.g., out-of-band).

In some embodiments, the security awareness of the GSLB system is implemented on an application by application basis. That is, the determination of which datacenter to assign a client of a particular application to will be affected by security data relevant only to that particular application. However, in other embodiments, the security awareness of the GSLB system is implemented on a multi-application basis. That is, the determination of which datacenter to assign a client of a particular application will be affected by security data relevant to other applications.

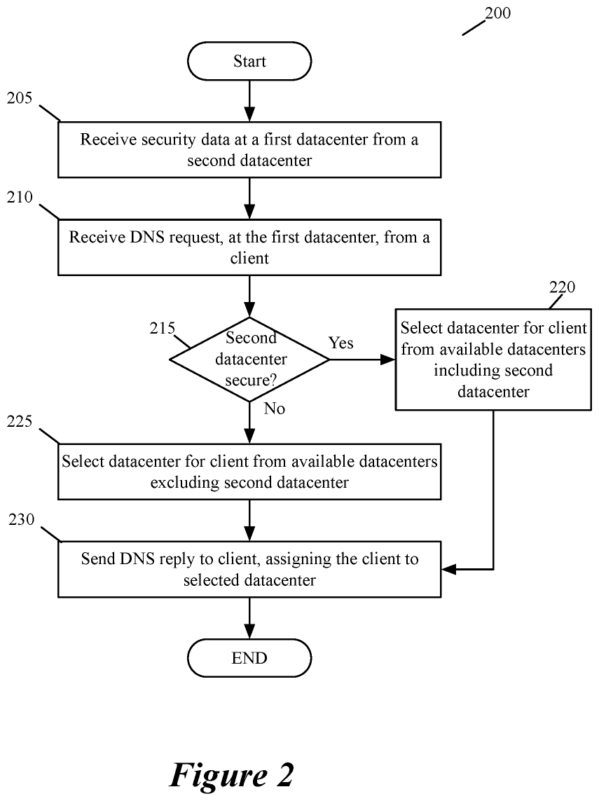

FIG. 2 conceptually illustrates a process 200 of some embodiments for selecting and sending a DNS reply to a client. The process 200 receives (at 205) security data at a first datacenter from a second datacenter. In some embodiments, the security data is sent from the second datacenter to the first datacenter directly, in other embodiments, the security data is sent from the second datacenter to some other datacenter before being forwarded to the first datacenter, either in the same form as it was sent from the second datacenter or in some modified form such as an analyzed or condensed form of the security data sent from the second datacenter. The security data in some embodiments may include routine security status updates, e.g., indicating that the second datacenter does not have any security issues, alerts that the second datacenter is not secure, or cancelations of earlier alerts.

The process 200 then receives (at 210) a DNS request, at the first datacenter, from a client. The DNS request may be received at a DNS cluster of the first datacenter which then assigns a DNS service engine to handle the request. The process 200 then determines (at 215), based on the received security data, whether the second datacenter is secure. When the second datacenter is secure, the process 200 selects (at 220) a datacenter from among the available datacenters, including the second datacenter, then sends (at 230) a DNS reply, to the client, assigning the client to the selected datacenter. When the second datacenter is not secure, the process 200 selects (at 225) a datacenter from among the available datacenters, excluding the second datacenter, then sends (at 230) a DNS reply, to the client, assigning the client to the selected datacenter. The process 200 then ends.

As mentioned above, various embodiments use different elements to gather metrics to produce the security data including (1) a smart network interface card (smartNIC) of a server or host computer of the datacenter, (2) a load balancer 117, (3) load balancer agents on the BESs 105a-d, (4) DNS clusters 120a-c (or DNS service engines 125a-c), (5) DNS cluster agents operating on the BESs 105a-d, and/or (6) another agent on the host computer of the backend server. Additionally, different embodiments may distribute data through different elements. FIGS. 3 and 4 provide two examples of embodiments that use different elements to gather and distribute security data. However, one of ordinary skill in the art will understand that the present invention is not limited to these examples and can gather and distribute security data through a variety of elements. Some embodiments may gather and/or distribute security data using more than one element (e.g., using agents on the backend servers and the load balancers).

FIG. 3 illustrates operations of security elements of a host computer 300 of a datacenter that is under a DOS attack. FIG. 3 includes BESs 105a, controllers 110a, load balancer cluster 115a, and DNS cluster 120a, previously described in relation to FIG. 1. FIG. 3 also includes host computer(s) 300 and interface cards (smartNICs) 310/Host computer(s) 300 implement BES 105a, DNS cluster 120a, and LBC 115a. BES 105a has a security agent 320. The operation of identifying an attack and disseminating security data relating to the backend servers 105a takes multiple steps. First, smartNICs 310 identify an attack (in this example, the attack is a DOS attack). Second, the security agent 320 receives reports, warnings, alerts or other data about the attack from the smartNICs 310 and generate security data based on those reports. In some embodiments, the security agents 320 query the smartNICs 310 for the reports. In other embodiments, the smartNICs 310 automatically send the reports to the security agents. In still other embodiments, rather than smartNICs, other hardware, software, or combination of hardware and software identifies attacks and produces reports that are received by the security agents 320.

Third, the security agent 320 sends security data identifying the attack to the DNS cluster 120a. Fourth, the DNS cluster 120a sends security data identifying the attack on the BES 105a of datacenter 102 to the DNS clusters (not shown) of other datacenters (not shown) in the GSLB system. In some embodiments, a single datacenter may include multiple host computers 300 that include DNS clusters, BESs, load balancers, and/or controllers. In such embodiments, whichever element distributes the security data to other datacenters, or some other element on a host computer 300, also distributes the security data to other host computers 300 in the same datacenter. Here, as part of the fourth step, the DNS cluster 120a also sends the security data to other DNS clusters in the same datacenter as host computer 300. Fifth, the DNS cluster 120a notifies the local LBC 115a that the BES 105a of the host computer 300 is under attack. Notifying the LBC 115a prompts the load balancers of LBC 115a to avoid assigning clients to the BESs 105a (in some embodiments including the BESs on other host computers of the datacenter).

The illustrated embodiment shows certain specific elements operating in specific machines. However, other embodiments may implement such elements on other machines. For example, although the security agents 320 are shown as operating on BES 105a and smartNICs 310 are shown as operating on host machines 300, in other embodiments, such security agents may be operated on other elements of the host computer 300 (instead of or on addition to operating on the BES 105a), on separate computers or devices implementing DNS functions and/or LB functions, etc. Similarly, although the security agent 320 in illustrated embodiments is shown as monitoring smartNICs 310 on the same host computer 300 as the security agents 320, in other embodiments, the security agents 320 may monitor smartNICs 310, other security hardware, software operating on other computers or devices (different from the computers that implement security agents 320).

As previously mentioned, in some embodiments, security data is disseminated through the DNS clusters of datacenters. However, in other embodiments, security data is passed through other datacenter elements, such as controllers. Embodiments that disseminate security data through controllers may do so because there are individual host computers or even entire datacenters without DNS clusters. On such host computers or datacenters, other elements are used to disseminate the security data once it has been collected. In other embodiments, even host computers that have DNS clusters may use controllers to disseminate security data. One possible advantage to avoiding using DNS clusters to disseminate data would be because those DNS clusters might themselves be targeted as part of attacks such as DOS attacks.

FIG. 4 illustrates operations of security elements of a host computer 300 of a datacenter that passes security data through controllers 110a instead of DNS cluster 120a. FIG. 4 includes BES 105a, one or more controllers 110a, load balancer cluster 115a, and DNS cluster 120a, previously described in relation to FIG. 1. FIG. 4 also includes additional elements of the LBC 115a, specifically a security agent 410 operating on the LBC 115a that collects metrics, alerts, or reports from the smartNIC 310 and produces security data. The operation of identifying an attack and disseminating security data relating to the backend servers 105a takes multiple steps. First, smartNICs 310 of the BES identify an attack (in this example, the attack is a DOS attack). Second, the security agent 410 receives reports, warnings, or other data about the attack from the smartNICs 310 and generates security data based on those reports. In some embodiments, the security agent 410 queries the smartNICs 310 for the reports. In other embodiments, the smartNICs 310 automatically send the reports to the security agent 410. In still other embodiments, rather than smartNICs, other hardware, software, or combination of hardware and software identifies attacks and produces reports that are received by the security agent 410.

Third, the security agent 410 sends security data identifying the attack to the controllers 110a. Fourth, the controllers 110a send security data identifying the attack on the BES 105a of host computer 300 of the datacenter to the controllers of other datacenters (not shown) in the GSLB system. In some embodiments, the controllers 110a also send the security data to other host computers (not shown), e.g., to the controllers (not shown) of the other host computers.

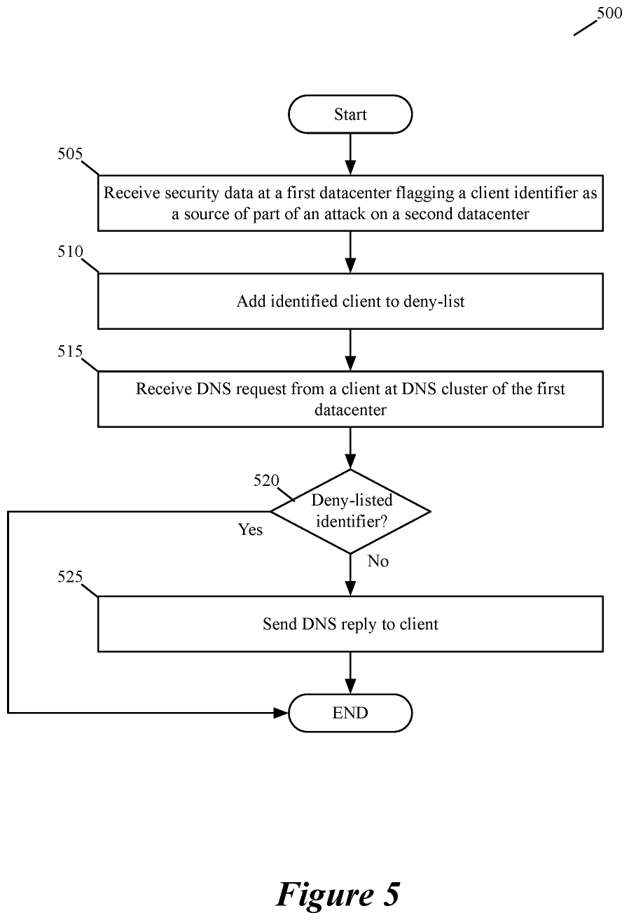

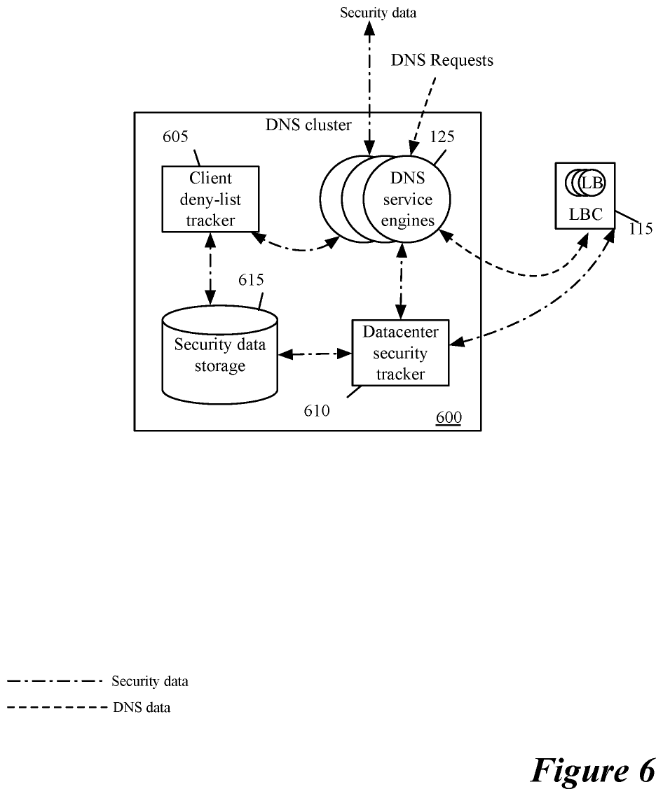

Fifth, the controllers 110a sends security data about the attack to the DNS cluster 120a (e.g., to add identifiers of the attackers to a deny-list as further described with respect to FIGS. 5 and 6, below). In this embodiment, since the security agent 410 is part of the LBC 115a, the security agent 410 prompts the load balancers of LBC 115a to avoid assigning clients to the BES 105a of the datacenter. In some embodiments, in addition to or instead of the security agent 410 directly notifying the LBC 115a of the attack, the controllers 110a notify the LBC 115a of the attack (e.g., in order to maintain consistency with the way that security data from other host computers is disseminated). In some embodiments, LBC 115a sends security data about the attack to the DNS cluster 120a on the same host computer that was attacked instead of or in addition to the controller 110a sending the security data.

The preceding FIGS. 2-4 illustrated embodiments in which the security aware GSLB system protected the clients by assigning them to more secure datacenters (e.g., datacenters that were not under attack, datacenters where not all security patches have been applied, etc.). However, in some embodiments, in addition to or instead of directing clients away from less secure datacenters, the security aware GSLB system also protects datacenters from potential attacks. In such embodiments, the security data sent from a datacenter under attack to other datacenters includes client identifiers of clients that are involved in the attack.

FIG. 5 conceptually illustrates a process 500 for protecting a datacenter from a client involved in an attack on another datacenter in a security aware GSLB system. The process 500 receives (at 505) security data at a first datacenter flagging a client identifier as a source of part of an attack on a second datacenter. Here, the term “client” includes any devices that send a DNS request to a datacenter in an attempt to receive access to the application servers. In some embodiments, the client identifier is an IP address of the client.

The process 500 then adds (at 510) the identified client to a deny-list of clients that the DNS cluster should not supply an IP address (e.g., a VIP address) to. In some embodiments, this deny-list is a source-IP deny-list that contains the IP addresses of the clients on the deny-list. However, in other embodiments, the deny-list may include additional or different client identifier(s) such as a MAC address, source port address, etc. In some embodiments, the deny-list may contain ranges of IP addresses as well as individual IP addresses.

Later, the process 500 receives (at 515) a DNS request from a client at the DNS cluster of the first datacenter. One of ordinary skill in the art will understand that a DNS request includes a source IP address and/or other identifiers for the client that sent the request. The process 500 determines (at 520) whether the identified client in the DNS request is on the deny-list. For example, if the client identifier is the source IP address, the DNS cluster will determine whether the source IP address is on the source-IP deny-list. If the client is not on the deny-list, then the process 500 sends (at 525) a DNS reply to the client and then ends. One of ordinary skill in the art will understand that, in some embodiments, the DNS cluster will query an LBC in order to identify an IP address to include in the DNS reply to the client.

If the client is on the deny-list, then the process 500 ends without sending a DNS reply to the client. By not sending a DNS reply, the process 500 protects application servers to which the attacking client might have been assigned. The protected servers include any servers that the LBC of the first datacenter could have assigned the client to. One of ordinary skill in the art will understand that in some embodiments, there are additional operations triggered by matching a client identifier to the deny-list. For example, in some embodiments, an attempt by a client on the deny-list to obtain an IP address may be noted in a security report and/or some kind of response to the DNS request (other than a DNS reply assigning the client to a backend server of the application) could be sent to the source IP address. The client deny-listing process 500 in some embodiments applies to clients involved in attacks only on the same application for which the client seeks a DNS request. However, in other embodiments, the process 500 may apply to clients involved in attacks on other applications at datacenters used by the GSLB system.

FIG. 6 illustrates a DNS cluster 600 of some embodiments. The DNS cluster 600 includes multiple DNS service engines 125, a client deny-list tracker 605, a datacenter security tracker 610, and a security data storage 615. The DNS cluster 600 communicates with LBC 115. One of ordinary skill in the art will understand that some or all of the elements of the DNS cluster 600 may be implemented as hardware, software, or a combination of hardware and software. Additionally, in some embodiments, the operations described as being performed by multiple elements may be performed by a single element, and/or operations described as being performed by a single element may be performed by multiple elements.

The DNS service engines receive DNS requests and security data. The DNS service engines 125 query the client deny-list tracker about each DNS request (to determine whether the client that sent the request is on the deny-list). Additionally, the DNS service engines 125 sends security data, e.g., received from other datacenters, that identifies clients on the deny-list to the client deny-list tracker. The client deny-list tracker 605 stores the client identifying data of the clients on the deny-list in the security data storage 615. The client deny-list tracker 605 also queries the security data storage 615 when the DNS service engines 125 query the client deny-list tracker 605 when a DNS request is received from a client to determine whether that client is on the deny-list.

The DNS service engines 125 also supply security data, relating to the status of the datacenters in the GSLB system, to the datacenter security tracker 610. The datacenter security tracker 610 stores the security information in the security data storage 615 and provides relevant security data to the LBC 115. For example, if a datacenter is under a DOS attack, the datacenter security tracker 610 would direct the LBC 115 to avoid (partially or entirely) assigning clients to the datacenter that is under attack. Similarly, if the application servers of a datacenter lack the most recent security patches or updates, the datacenter security tracker 610 of some embodiments may direct the LBC 115 to preferentially assign clients to other datacenters where the latest security patches have been applied. Avoiding the unpatched datacenters may have multiple advantages such as keeping the current clients safer while also reducing the load on the unpatched datacenters while administrators of those datacenters apply the patches or updates. Although the DNS cluster 600 of FIG. 6 sends security data directly from the datacenter security tracker 610 to the LBC 115, one of ordinary skill in the art will understand that, in some embodiments, the security data is sent to the LBC 115 from the DNS service engines instead of from the datacenter security tracker 610.

Many of the above-described features and applications are implemented as software processes that are specified as a set of instructions recorded on a computer-readable storage medium (also referred to as computer-readable medium). When these instructions are executed by one or more processing unit(s) (e.g., one or more processors, cores of processors, or other processing units), they cause the processing unit(s) to perform the actions indicated in the instructions. Examples of computer-readable media include, but are not limited to, CD-ROMs, flash drives, RAM chips, hard drives, EPROMs, etc. The computer-readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the invention. In some embodiments, the software programs, when installed to operate on one or more electronic systems, define one or more specific machine implementations that execute and perform the operations of the software programs.

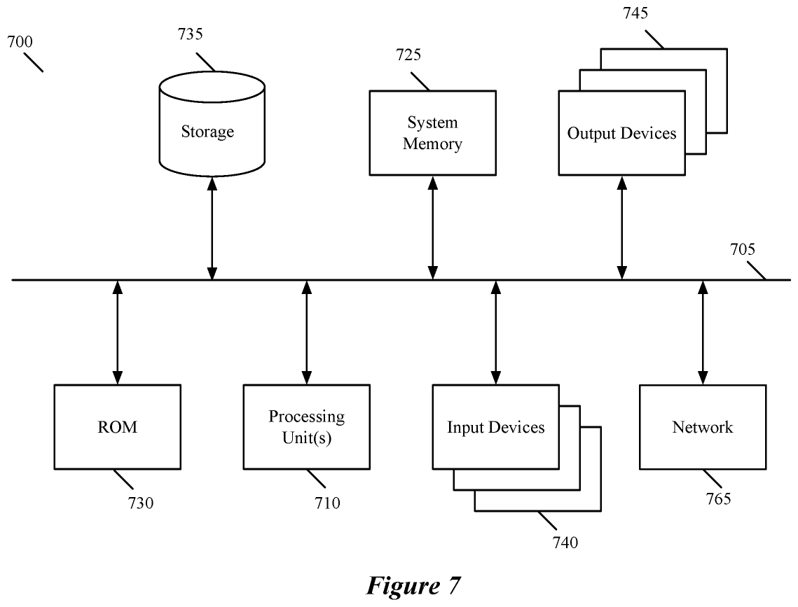

FIG. 7 conceptually illustrates a computer system 700 with which some embodiments of the invention are implemented. The computer system 700 can be used to implement any of the above-described hosts, controllers, gateway and edge forwarding elements. As such, it can be used to execute any of the above-described processes. This computer system 700 includes various types of non-transitory machine-readable media and interfaces for various other types of machine-readable media. Computer system 700 includes a bus 705, processing unit(s) 710, a system memory 725, a read-only memory 730, a permanent storage device 735, input devices 740, and output devices 745.

The bus 705 collectively represents all system, peripheral, and chipset buses that communicatively connect the numerous internal devices of the computer system 700. For instance, the bus 705 communicatively connects the processing unit(s) 710 with the read-only memory 730, the system memory 725, and the permanent storage device 735.

From these various memory units, the processing unit(s) 710 retrieve instructions to execute and data to process in order to execute the processes of the invention. The processing unit(s) may be a single processor or a multi-core processor in different embodiments. The read-only-memory (ROM) 730 stores static data and instructions that are needed by the processing unit(s) 710 and other modules of the computer system. The permanent storage device 735, on the other hand, is a read-and-write memory device. This device is a non-volatile memory unit that stores instructions and data even when the computer system 700 is off. Some embodiments of the invention use a mass-storage device (such as a magnetic or optical disk and its corresponding disk drive) as the permanent storage device 735.

Other embodiments use a removable storage device (such as a floppy disk, flash drive, etc.) as the permanent storage device 735. Like the permanent storage device 735, the system memory 725 is a read-and-write memory device. However, unlike storage device 735, the system memory 725 is a volatile read-and-write memory, such as random access memory. The system memory 725 stores some of the instructions and data that the processor needs at runtime. In some embodiments, the invention's processes are stored in the system memory 725, the permanent storage device 735, and/or the read-only memory 730. From these various memory units, the processing unit(s) 710 retrieve instructions to execute and data to process in order to execute the processes of some embodiments.

The bus 705 also connects to the input and output devices 740 and 745. The input devices 740 enable the user to communicate information and select commands to the computer system 700. The input devices 740 include alphanumeric keyboards and pointing devices (also called “cursor control devices”). The output devices 745 display images generated by the computer system 700. The output devices 745 include printers and display devices, such as cathode ray tubes (CRT) or liquid crystal displays (LCD). Some embodiments include devices such as touchscreens that function as both input and output devices 740 and 745.

Finally, as shown in FIG. 7, bus 705 also couples computer system 700 to a network 765 through a network adapter (not shown). In this manner, the computer 700 can be a part of a network of computers (such as a local area network (“LAN”), a wide area network (“WAN”), or an Intranet), or a network of networks (such as the Internet). Any or all components of computer system 700 may be used in conjunction with the invention.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra-density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessors or multi-core processors that execute software, some embodiments are performed by one or more integrated circuits, such as application-specific integrated circuits (ASICs) or field-programmable gate arrays (FPGAs). In some embodiments, such integrated circuits execute instructions that are stored on the circuit itself.

As used in this specification, the terms “computer”, “server”, “processor”, and “memory” all refer to electronic or other technological devices. These terms exclude people or groups of people. For the purposes of the specification, the terms “display” or “displaying” mean displaying on an electronic device. As used in this specification, the terms “computer-readable medium,” “computer-readable media,” and “machine-readable medium” are entirely restricted to tangible, physical objects that store information in a form that is readable by a computer. These terms exclude any wireless signals, wired download signals, and any other ephemeral or transitory signals.

While the invention has been described with reference to numerous specific details, one of ordinary skill in the art will recognize that the invention can be embodied in other specific forms without departing from the spirit of the invention. For instance, several of the above-described embodiments deploy gateways in public cloud datacenters. However, in other embodiments, the gateways are deployed in a third-party's private cloud datacenters (e.g., datacenters that the third-party uses to deploy cloud gateways for different entities in order to deploy virtual networks for these entities). Thus, one of ordinary skill in the art would understand that the invention is not to be limited by the foregoing illustrative details, but rather is to be defined by the appended claims.

1. A method of protecting a plurality of datacenters that implement an application, the datacenter comprising a plurality of DNS clusters for assigning clients to the datacenters, the method comprising:
at a first datacenter:
receiving, from a second datacenter, a security notification identifying a set of clients that pose a security threat;
storing a set of identifiers associated with the set of clients on a deny-list;
prior to responding to a DNS request from a particular client, determining whether the particular client is on the deny-list;
rejecting the DNS request when the particular client is on the deny-list; and
processing the DNS request when the particular client is not on the deny-list.

2. The method of claim 1, wherein the identifiers comprise IP addresses.

3. The method of claim 1, wherein the set of identifiers comprises a range of IP addresses.

4. The method of claim 1, wherein the deny-list comprises a plurality of additional sets of identifiers associated with a plurality sets of additional clients.

5. The method of claim 4, wherein each of the plurality of additional sets of clients was identified as a threat by one or more of the additional datacenters.

6. The method of claim 1, wherein the second datacenter identified the set of clients as a threat for attempting a denial of service (DOS) attack on the second datacenter.

7. The method of claim 6, wherein the DOS attack was against servers at the datacenter that implement the application.

8. The method of claim 1, wherein the second datacenter identified at least a portion of the set of clients as a threat for attempting at least one of a URL misinterpretation attack, an SQL query poisoning attack, a reverse proxying attack, and a session hijacking attack.

9. The method of claim 1, wherein the second datacenter identified at least a portion of the set of clients as a threat for attempting at least one of a SYN attack and a reset (RST) attack.

10. The method of claim 1, wherein the second datacenter identified at least a portion of the set of clients as a threat for attempting at least one of an attack that comprises sending packets that are bad and/or malformed at the physical and/or data link layers (L1/L2 layers) and volumetric attacks.

11. A non-transitory machine readable medium storing a program that, when executed by one or more processing units of a first datacenter, protects a plurality of datacenters that implement an application, the datacenters comprising a plurality of DNS clusters for assigning clients to the datacenters, the program comprising sets of instructions for:
receiving, from a second datacenter, a security notification identifying a set of clients that pose a security threat;
storing a set of identifiers associated with the set of clients on a deny-list;
prior to responding to a DNS request from a particular client, determining whether the particular client is on the deny-list;
rejecting the DNS request when the particular client is on the deny-list; and
processing the DNS request when the particular client is not on the deny-list.

12. The non-transitory machine readable medium of claim 11, wherein the identifiers comprise IP addresses.

13. The non-transitory machine readable medium of claim 11, wherein the set of identifiers comprises a range of IP addresses.

14. The non-transitory machine readable medium of claim 11, wherein the deny-list comprises a plurality of additional sets of identifiers associated with a plurality sets of additional clients.

15. The non-transitory machine readable medium of claim 14, wherein each of the plurality of additional sets of clients was identified as a threat by one or more of the additional datacenters.

16. The non-transitory machine readable medium of claim 11, wherein the second datacenter identified the set of clients as a threat for attempting a denial of service (DOS) attack on the second datacenter.

17. The non-transitory machine readable medium of claim 16, wherein the DOS attack was against servers at the datacenter that implement the application.

18. The non-transitory machine readable medium of claim 11, wherein the second datacenter identified at least a portion of the set of clients as a threat for attempting at least one of a URL misinterpretation attack, an SQL query poisoning attack, a reverse proxying attack, and a session hijacking attack.

19. The non-transitory machine readable medium of claim 11, wherein the second datacenter identified at least a portion of the set of clients as a threat for attempting at least one of a SYN attack and a reset (RST) attack.

20. The non-transitory machine readable medium of claim 11, wherein the second datacenter identified at least a portion of the set of clients as a threat for attempting at least one of an attack that comprises sending packets that are bad and/or malformed at the physical and/or data link layers (L1/L2 layers) and volumetric attacks.
